(19) United States
(12) Patent Application Publication
(10) Pub. No.: US 2005/0110246 A1
(43) Pub. Date: May 26, 2005

(54) Gas bag module

(75) Inventor: Michael Schneider, Sulzbach (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/992,882

(22) Filed: Nov. 19, 2004

(30) Foreign Application Priority Data
Nov. 20, 2003 (DE) 203 17 961.7

(51) Int. Cl. B60R 21/20

(52) U.S. Cl. 280/728.2

(57) ABSTRACT

A gas bag module has a gas bag, a gas generator, a retainer ring and a generator carrier to which the gas bag and the gas generator are secured by means of the retainer ring. The retainer ring comprises at least one first latching element for creating a latching connection between the retainer ring and the generator carrier and at least one second latching element for creating a latching connection between the gas generator and the retainer ring.

### FILED OF THE INVENTION

The invention relates to a gas bag module.

### BACKGROUND OF THE INVENTION

In securing a gas generator and a gas bag to a generator carrier of a driver side gas bag module a so-called holding or retaining ring is often used, which clamps a rim of the inflow opening of the gas bag between itself and the generator carrier and simultaneously fixes, for example also via a clamping action, the gas generator at the generator carrier. The connection between generator carrier, gas generator and retainer ring is conventionally effected via a nut and bolt connection. This assembly step is very time-consuming.

### BRIEF SUMMARY OF THE INVENTION

It is an object of the present invention to reduce the assembly time in assembling the gas bag module considerably.

This is achieved in a gas bag module having a gas bag, a gas generator, a retainer ring and a generator carrier to which the gas bag and the gas generator are secured by means of the retainer ring. The retainer ring comprises at least one first latching element for creating a latching connection between the retainer ring and the generator carrier and at least one second latching element for creating a latching connection between the gas generator and the retainer ring. Both the gas generator and the retainer ring can thus be fastened purely via latching connections, which results in a considerable saving on assembly time compared with a nut and bolt connection. It is possible to first of all fix the gas generator via the at least one second latching element at the retainer ring and then to lock the assembly unit consisting of gas generator and retainer ring into place at the generator carrier, the gas bag being secured in this working step as well.

The generator carrier may be part of a module housing closing the gas bag module off towards the exterior. It further may serve to fasten the complete gas bag module to a vehicle, e.g. directly to a skeleton of a steering wheel. The retainer ring is a part separate from the generator carrier and the generator carrier is a part separate from a covering cap.

Preferably, the retainer ring comprises a clamping section, and a rim of the inflow opening of the gas bag is located between the clamping section and the generator carrier. In order to uniformly and gas-tightly clamp the rim of the inflow opening over its entire periphery the clamping section may, as regards its periphery, completely surround the retainer ring, i.e. it may be annular.

The terms “annular” or “ring” do not denote here solely a component in the shape of a circular ring, but also other closed forms having a recess located inside.

As seen in an axial direction of the gas bag module, there are preferably located one behind the other a flange of the gas generator, the clamping section, the rim of the inflow opening as well as a section of the generator carrier. This offers the advantage that the thrust generated by the gas flowing out of the gas generator when the latter is activated may be transferred via the clamping section of the retainer ring to the rim of the inflow opening of the gas bag, and thus the gas bag is additionally fixed by the pressure towards the generator carrier during inflation.

Here, an edge of the flange of the gas generator may be located radially inwards of the clamping section. In this arrangement as well, the force exerted by the gas generator may be converted into a clamping of the gas bag.

When the gas generator is surrounded by the retainer ring, the retainer ring can be designed compact in the radial direction, which permits a good force transmission.

The first latching element preferably engages an edge of a flange of the gas generator so that a conventional gas generator may be used.

In order to fix the retainer ring at the generator carrier under prestress it is preferably provided for that the first latching element comprises a slanted contact surface against which the generator carrier rests in the assembled state. This may for example avoid rattling.

Preferably, the second latching element comprises a slanted contact surface against which the gas generator rests in the assembled state in order to fix the gas generator at the retainer ring under prestress.

At least one of the first and the second latching elements is preferably formed integrally with the retainer ring.

The number of the first and second latching elements may vary depending on the design of the gas bag module, preferably however at least three first latching elements and at least three second latching elements, respectively, are provided.

Each of the first and/or second latching elements may be designed as a hook.

In one embodiment of the invention the retainer ring is located in an opening in the generator carrier and surrounded by a border of the opening, the first latching element engaging the border of the opening.

In a further embodiment of the invention the generator carrier may be a housing having a bottom plate. In this arrangement the bottom plate is preferably provided with an opening in the region of the gas generator and a rim of the opening is bent at least in sections so that a contact surface complementary to the first latching element is created. This configuration is particularly favourable in the case of generator carriers having a bottom plate made of a sheet metal. The generator carrier may be directly attachable to a vehicle, e.g. to a steering wheel skeleton, via further fasteners.

### BRIEF DESCRIPTION OF THE DRAWINGS

In the drawings:

FIG. 1 shows a schematic partial sectional view of a gas bag module in accordance with the invention according to a first embodiment of the invention;

FIG. 2 shows an enlarged detail of FIG. 1;

FIG. 3 shows an enlarged detail of FIG. 2;

FIG. 4 shows a detail of the connection of a first latching element to the generator carrier of a gas bag module according to a second embodiment of the invention in a sectional view;

FIG. 5 shows a schematic partial sectional view of a gas bag module in accordance with the invention according to a third embodiment; and

FIG. 6 shows a section through the module along the line VI-VI in FIG. 5.

### DETAILED DESCRIPTION OF PREFERRED EMBODIMENTS

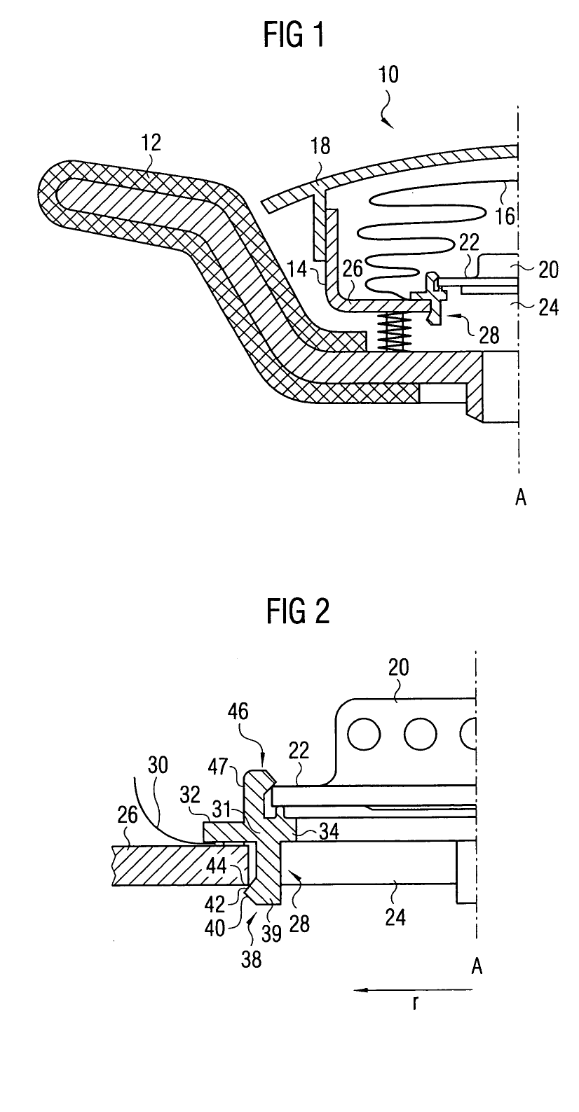

In FIG. 1 there is illustrated a gas bag module 10 according to a first embodiment of the invention, which is accommodated in a steering wheel 12. It includes a generator carrier 14 consisting in this example of plastic material and forming a mount in which a gas bag 16 is accommodated in a folded state. Outwards, i.e. facing towards the interior of the vehicle in a state installed in the vehicle, the gas bag module 10 is closed in a conventional manner by a covering cap 18. The gas bag module 10 is attached to a vehicle-fixed part, e.g. a steering wheel skeleton, via known fasteners indicated in FIG. 1.

The generator carrier 14 could just as well be designed in the form of a plate, and the side walls of the mount could be formed by other components of the steering wheel or of the gas bag module.

The gas bag module 10 moreover includes a gas generator 20 which is surrounded by an annular flange 22 and located somewhat above an opening 24 in a bottom plate 26 of the generator carrier 14. The gas generator 20 is secured to the bottom plate 26 of the generator carrier 14 by means of a retainer ring 28 separate from the generator carrier 14 which is described in more detail in the following.

The retainer ring 28 also fixes simultaneously a rim 30 of an inflation opening of the gas bag 16 at the generator carrier 14.

The retainer ring 28 comprises an annular section 31. A part of the annular section 31 located radially outside forms a clamping section 32 for fixing the rim 30 of the inflation opening of the gas bag 16. The rim 30 of the inflation opening of the gas bag 16 is held between the clamping section 32 and the bottom plate 26 of the generator carrier 14.

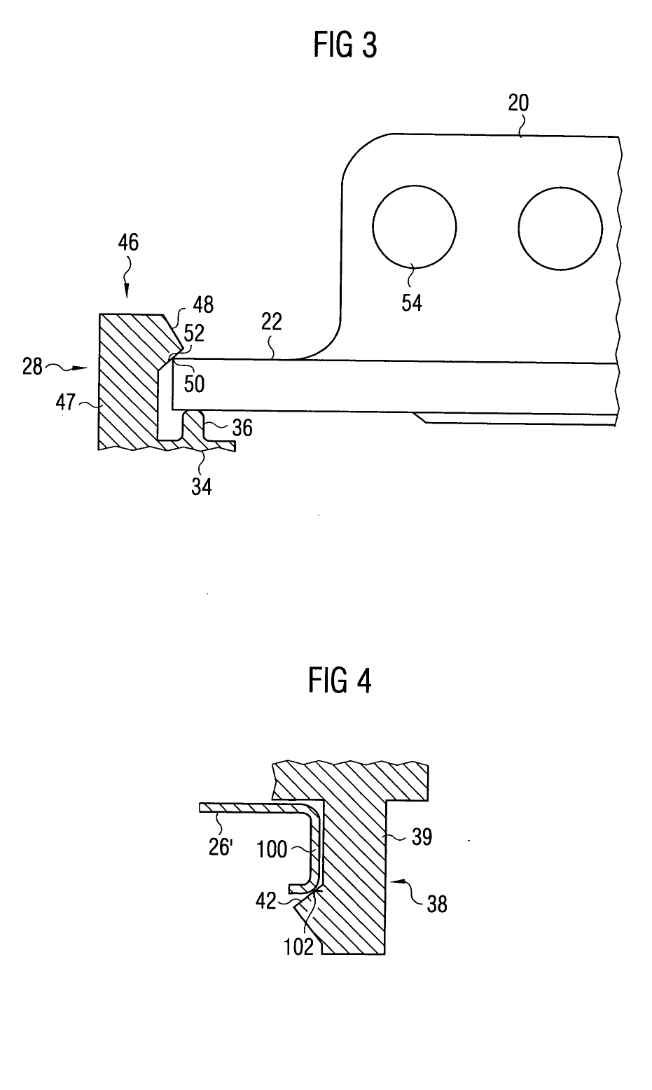

A radially inner part of the annular section forms a supporting section 34. At the supporting section 34 there is formed an annular, surrounding protrusion 36 on which the flange 22 of the gas generator 20 sealingly rests (see FIG. 3). There could also be provided several protrusions 36 separated from each other, which are distributed over the periphery. The protrusion or protrusions 36 also serve for the prestressing in the axial direction A, because they are axially elastically compressed when the flange 22 locks into place.

The clamping section 32 and the supporting section 34 are integrally connected to each other.

Seen in an axial direction A of the gas bag module 10, i.e. perpendicular to the plane of the annular section 31 of the retainer ring 28, several, in this arrangement four, first latching elements 38 integrally formed with the retainer ring 28 and designed in the form of hooks extend from the latter, whose arms 39 are facing away from a front side of the covering cap 18. The arms 39 of the first latching elements 38 are movable over a small angular range in a radial direction r to permit a locking into place at a rim of the opening 24 of the bottom plate 26. For this purpose each first latching element 38 carries at the end of the arm 39 facing away from the annular section 31 a slanted sliding surface 40.

Each of the first latching elements 38 contacts the rim of the opening 24 via a slanted contact surface 42 formed at the end of the arm 39 and facing towards the annular section, an edge 44 of the rim of the opening 24 resting on the contact surface 42. Thus, the rim of the opening 24 is fixed between the clamping section 32 and the contact surface 42 at the first latching element 38. On account of the slant of the contact surface it is ensured that the latching connection between the first latching elements 38 and the rim of the opening 24 is always under prestress.

Proceeding from the annular section 31 of the retainer ring 28 several, in this arrangement four, hook-shaped second latching elements 46 formed integrally with the retainer ring 28 extend in the direction opposite to the first latching elements 38. The flange 22 of the gas generator 20 is connected to the retainer ring 28 via the second latching elements 46. This latching connection is shown in more detail in FIG. 3.

The second latching elements 46 each comprise at the end of an arm 47 a slanted sliding surface 48 facing away from the annular section 31. The arms 47 are movable over a small angular range in the radial direction r so that the gas generator 20 may be pushed in a purely translatory movement in the axial direction A of the gas bag module towards the annular section 31 of the retainer ring 28. In so doing the arms 47 of the second latching elements 46 radially yield outwards a little until they encompass the flange 22. The flange 22 then rests on the protrusion or protrusions 36 of the supporting section 34 and is fixed between this section and the contact surface 52 at the second latching element 46.

An edge 50 at the rim of the flange 22 is in contact with a slanted contact surface 52 which faces towards the annular section 31 and is formed at the end of the arm 47 of each second latching element 46. It is ensured by this measure that the flange 22 is always maintained with a prestress between the contact surface 52 and the protrusion 36.

The first latching elements 38 are located radially inwards of the second latching elements 46. The edge of the flange 22 of the gas generator 20 is located radially inwards of the clamping section 32.

Seen in the axial direction A, the flange 22 of the gas generator 20, the clamping section 32 of the retainer ring 28, the rim 30 of the inflow opening of the gas bag 16 and the bottom plate 26 of the generator carrier 14 are located one behind the other. This results in that upon activation of the gas generator 20 the impulse generated by the gas emerging from outflow openings 54 is transferred via the supporting section 34 and the clamping section 32 to the rim 30 of the gas bag 16 and the bottom plate 26. In this way the clamping effect between the retainer ring 28 and the generator carrier 14 is increased exactly at the moment in which a firm fastening of the gas bag 16 is necessary.

It would be possible as well to provide the rim 30 of the inflow opening of the gas bag 16 with openings through which the arms 39 of the first latching elements 38 protrude to additionally fasten the gas bag 16 in this way.

In the assembly of the gas bag module 10 the gas generator 20 is first of all locked into place at the retainer ring 28 in a purely translatory relative movement to the latter. Afterwards the assembly unit consisting of gas generator 20 and retainer ring 28 is placed in the gas bag 16 through the inflow opening, and the assembly unit thus formed is mounted in the generator carrier 14. For this purpose the arms 39 of the first latching elements 38 are inserted in a purely translatory movement into the opening 24 in the axial direction A until the contact surfaces 42 are in engagement with the rim of the bottom plate 26. In order to clearly determine the position of the rim 30 of the inflow opening of the gas bag 16 during assembly, a certain prestress exists between the retainer ring 28 and the bottom plate 26.

The retainer ring 28 can consist completely of metal or a suitable plastic material.

In contrast to the first embodiment of the invention, in a second embodiment the bottom plate 26′ of the generator carrier 14 is formed of a relatively thin sheet metal. In this arrangement in the region of the first latching elements 38 there are provided sections in which the material of the rim of the opening 24 of the bottom plate 26′ is bent in such a way that contact surfaces 100 complementary to the first latching element 38 are created. Also in this arrangement a border 102 of the contact surface 100 is in contact with the slanted contact surface 42 of the first latching elements 38 so that a prestressing between each first latching element 38 and the bottom plate 26′ exists in this arrangement as well.

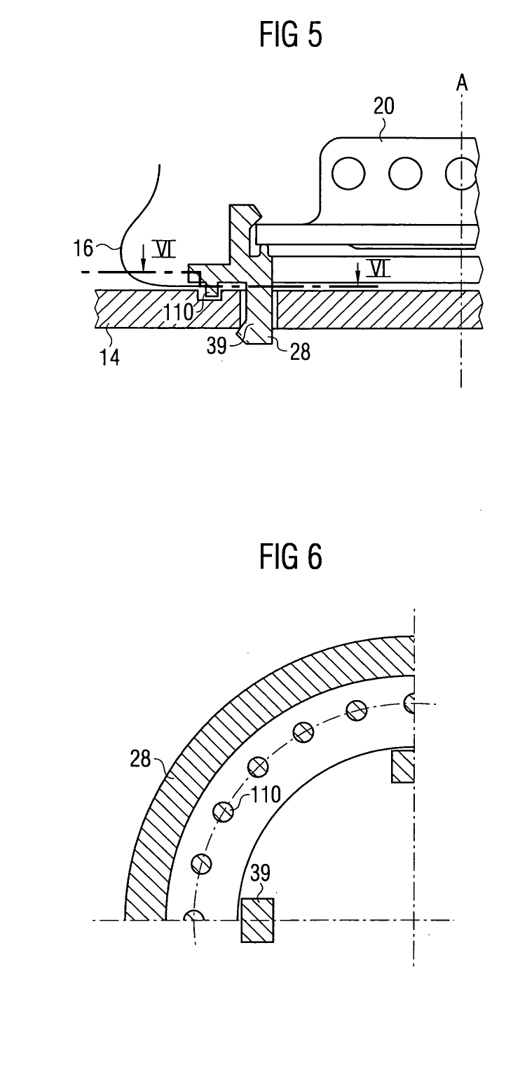

In the embodiment according to FIG. 5 the gas bag 16 is located between the retainer ring 28 and the generator carrier 14. On its underside the retainer ring 28 comprises numerous protrusions 110 protruding into corresponding openings in the gas bag 16 and permitting a definite determination of the position of the gas bag 16.

When the gas generator 20 is activated, the latter and the retainer ring 28 are pushed downwards on account of the pressure in the gas bag and the thrust of the gas generator so that in addition to the form fit the gas bag 16 is also clamped between retainer ring 28 and generator carrier 14.

1. A gas bag module comprising:
a gas bag (16),
a gas generator (20),
a retainer ring (28) and
a generator carrier (14) to which said gas bag (16) and said gas generator (20) are secured by means of said retainer ring (28),
said retainer ring (28) comprising at least one first latching element (38) for creating a latching connection between said retainer ring (28) and said generator carrier (14), and at least one second latching element (46) for creating a latching connection between said gas generator (20) and said retainer ring (28).

2. The gas bag module according to claim 1, wherein said retainer ring (28) comprises a clamping section (32), and a rim (30) of an inflow opening of said gas bag (16) is located between said clamping section (32) and said generator carrier (14).

3. The gas bag module according to claim 2, wherein, as seen in an axial direction (A) of said gas bag module (10), a flange (22) of said gas generator (20), said clamping section (32), said rim (30) of said inflow opening as well as a section of said generator carrier (14) are arranged one behind the other.

4. The gas bag module according to claim 1, wherein an edge of a flange (22) of said gas generator (20) is located radially inwards of a clamping section (32) of said retainer ring (28).

5. The gas bag module according to claim 1, wherein said gas generator (20) is surrounded by said retainer ring (28).

6. The gas bag module according to claim 1, wherein said second latching element (46) engages an edge of a flange (22) of said gas generator (20).

7. The gas bag module according to claim 1, wherein at least one of said first and second latching elements (38, 46) is designed as a hook.

8. The gas bag module according to claim 1, wherein at least one of said first and second latching elements (38, 46) is formed integraly with said retainer ring (28).

9. The gas bag module according to claim 1, wherein said first latching element (38) comprises a slanted contact surface (42) against which said generator carrier (14) rests in an assembled state.

10. The gas bag module according to claim 1, wherein said second latching element (46) comprises a slanted contact surface (52) against which said gas generator (20) rests in an assembled state.

11. The gas bag module according to claim 1, wherein said retainer ring (28) is located in an opening (24) in said generator carrier (14) and surrounded by a rim of the opening (24), said first latching element (38) engaging said rim of said opening (24).

12. The gas bag module according to claim 1, wherein said generator carrier (14) is a housing having a bottom plate (26; 26′).

13. The gas bag module according to claim 12, wherein in a region of said gas generator (20) said bottom plate (26′) is provided with an opening (24) and a rim of said opening (24) is bent at least in sections so that a contact surface (100) complementary to said first latching element (38) is created.
